(19) United States
(12) Patent Application Publication
(10) Pub. No.: US 2025/0245876 A1
(43) Pub. Date: Jul. 31, 2025

(54) MACHINE-GENERATED IMAGE RECOGNITION METHOD AND APPARATUS, ELECTRONIC DEVICE, AND COMPUTER-READABLE STORAGE MEDIUM

(71) Applicant: TENCENT TECHNOLOGY (SHENZHEN) COMPANY LIMITED, Shenzhen (CN)

(72) Inventor: Xiaoshuai CHEN, Shenzhen (CN)

(21) Appl. No.: 19/184,922

(22) Filed: Apr. 21, 2025

Related U.S. Application Data
(63) Continuation of application No. PCT/CN2024/077381, filed on Feb. 18, 2024.

(30) Foreign Application Priority Data
Apr. 17, 2023 (CN) 202310432891.7

(51) Int. Cl. G06T 11/00; G06V 10/764

(52) U.S. Cl. CPC G06T 11/00; G06V 10/764

(57) ABSTRACT

A machine-generated image recognition method includes: obtaining description information of a target image to be recognized; performing image generation based on the description information of the target image in N image generation manners respectively, to obtain N machine-generated images, N being a positive integer greater than 1; comparing the target image with the N machine-generated images respectively, to obtain N first probability values respectively corresponding to the N image generation manners, each of the N first probability values indicating a probability that the target image is generated in the corresponding image generation manner; and determining, in response to that a first probability value corresponding to one of the N image generation manners is not less than a first threshold, that the target image is the machine-generated image.

### CROSS-REFERENCES TO RELATED APPLICATIONS

This application is a continuation of PCT Application No. PCT/CN2024/077381, filed on Feb. 18, 2024, which claims priority to Chinese Patent Application No. 202310432891.7, filed on Apr. 17, 2023, the entire contents of all of which are incorporated herein by reference.

### FIELD OF THE TECHNOLOGY

Embodiments of the present disclosure relate to the field of image recognition technologies, and in particular, to a machine-generated image recognition method and apparatus, an electronic device, a computer-readable storage medium, and a computer program product.

### BACKGROUND OF THE DISCLOSURE

Artificial intelligence generated content (AIGC) is a development direction of artificial intelligence (AI) that has currently attracted much attention. For example, a machine-generated image that simulates a photograph or a painting is generated in some image generation manners. However, because a difference between a machine-generated image and a non-machine-generated image is sometimes not clear, the machine-generated image and the non-machine-generated image need to be distinguished.

In some cases, a binary classification model is trained on an image data set that is manually marked as a machine-generated image or not a non-machine-generated image, and then whether a target image to be recognized is a machine-generated image is determined by using a trained binary classification model. However, an accuracy of recognition for machine-generated images by such foregoing binary classification model is often poor.

### SUMMARY

Embodiments of the present disclosure provide a machine-generated image recognition method and apparatus, an electronic device, a computer-readable storage medium, and a computer program product, which can improve accuracy of recognizing a machine-generated image.

Technical solutions of the embodiments of the present disclosure are implemented as follows:

An embodiment of the present disclosure provides a machine-generated image recognition method, performed by an electronic device, the method including: obtaining description information of a target image to be recognized; performing image generation based on the description information of the target image in N image generation manners respectively, to obtain N machine-generated images, N being a positive integer greater than 1; comparing the target image with the N machine-generated images respectively, to obtain first probability values respectively corresponding to the N image generation manners, each of the N first probability values indicating a probability that the target image is generated in the corresponding image generation manner; and determining, in response to that a first probability value corresponding to one of the N image generation manners is not less than a first threshold, that the target image is the machine-generated image.

An embodiment of the present disclosure provides a model training method, performed by an electronic device, the method including: obtaining at least one non-machine-generated image and description information of the non-machine-generated image; performing image generation based on the description information of the non-machine-generated image in N image generation manners respectively, to obtain machine-generated images, N being a positive integer greater than 1; constructing a contrastive learning data set based on the non-machine-generated image and the machine-generated images, the contrastive learning data set including at least one positive sample pair and at least one negative sample pair, each positive sample pair including two machine-generated images generated based on description information of a same non-machine-generated image in a same image generation manner, and each negative sample pair including two machine-generated images generated based on description information of a same non-machine-generated image in different image generation manners; training a contrastive recognition model by using the contrastive learning data set, to obtain a completely trained contrastive recognition model, the completely trained contrastive recognition model being configured to compare a target image to be recognized with N machine-generated images respectively, to obtain a first probability value indicating that the target image and any one of the N machine-generated images are generated in a same image generation manner, the N machine-generated images being generated based on description information of the target image in the N image generation manners respectively.

An embodiment of the present disclosure provides a machine-generated image recognition apparatus, including: an information obtaining module, configured to obtain description information of a target image to be recognized, the description information of the target image being information configured for describing content of the target image; an image obtaining module, configured to perform image generation based on the description information of the target image in N image generation manners respectively, to obtain N machine-generated images, N being a positive integer; a score determining module, configured to compare the target image with the N machine-generated images respectively, to obtain first probability values respectively corresponding to the N image generation manners, the first probability value indicating a probability that the target image is generated in the corresponding image generation manner; and an image recognition module, configured to determine, in response to that a first probability value corresponding to one of the N image generation manners is not less than a first threshold, that the target image is the machine-generated image.

An embodiment of the present disclosure provides an electronic device, including a processor and a memory, the memory having a computer program stored therein, and the computer program being loaded and executed by the processor to implement the foregoing machine-generated image recognition method, or implement the foregoing model training method.

An embodiment of the present disclosure provides a non-transitory computer-readable storage medium, having a computer program stored therein, the computer program being loaded and executed by a processor to implement the foregoing machine-generated image recognition method, or implement the foregoing model training method.

The technical solutions provided in the embodiments of the present disclosure can include the following beneficial effects:

A machine-generated image is generated by using description information of a target image to be recognized, and then contrastive recognition is performed on the target image and machine-generated images generated in some image generation manners, to determine a probability that the target image is the machine-generated image generated in the image generation manner, so that whether the target image is a machine-generated image can be determined. Because machine-generated images generated in a same image generation manner have a similarity, contrastive recognition is performed on a reversely generated machine-generated image and the target image, to better determine whether the target image is a machine-generated image, thereby increasing an accuracy rate of recognition for the machine-generated image.

It is to be understood that the foregoing general description and the following detailed description are merely for exemplary and explanatory purposes, and cannot limit the present disclosure.

### BRIEF DESCRIPTION OF THE DRAWINGS

FIG. 1 is a schematic diagram of a machine-generated image recognition method according to an embodiment of the present disclosure.

FIG. 2 is a schematic diagram of an implementation environment according to an embodiment of the present disclosure.

FIG. 3 is a flowchart of a machine-generated image recognition method according to an embodiment of the present disclosure.

FIG. 4 is a flowchart of a model training method according to an embodiment of the present disclosure.

FIG. 5 is a schematic diagram of a classification model according to an embodiment of the present disclosure.

FIG. 6 is a flowchart of a machine-generated image recognition method and a model training method according to an embodiment of the present disclosure.

FIG. 7 is a block diagram of a machine-generated image recognition apparatus according to an embodiment of the present disclosure.

FIG. 8 is a block diagram of a model training apparatus according to an embodiment of the present disclosure.

FIG. 9 is a block diagram of an electronic device according to an embodiment of the present disclosure.

### DESCRIPTION OF EMBODIMENTS

Exemplary embodiments are described in detail herein, and examples thereof are shown in the accompanying drawings. When the following descriptions are made with reference to the accompanying drawings, unless otherwise indicated, the same numbers in different accompanying drawings represent the same or similar elements. Implementations described in the following exemplary embodiments do not represent all implementations that are consistent with the present disclosure. On the contrary, the implementations are merely examples of methods that are described in detail in the appended claims and that are consistent with some aspects of the present disclosure.

In the embodiments of the present disclosure, a contrastive recognition model is trained by using computer vision and machine learning technologies, so that the contrastive recognition model can recognize whether a target image to be recognized is a machine-generated image. The computer vision (CV) technology is a science that studies how to use a machine to “see”, and furthermore, is machine vision that a camera and a computer are configured to replace human eyes to perform recognition, measurement, and the like on a target, and further perform graphic processing, so that the computer processes the target into an image more suitable for human eyes to observe or an image transmitted to an instrument for detection. As a scientific discipline, the computer vision studies related theories and technologies and attempts to establish an AI system that can obtain information from images or multidimensional data. The computer vision technology generally includes technologies such as image processing, image recognition, image semantic understanding, image retrieval, optical character recognition (OCR), video processing, video semantic understanding, video content/behavior recognition, three-dimensional object reconstruction, a three-dimensional (3D) technology, virtual reality, augmented reality, synchronous positioning, and map construction.

Machine learning (ML) is a multi-field interdisciplinary subject involving the probability theory, statistics, the approximation theory, convex analysis, the algorithm complexity theory, and the like. The ML specializes in studying how a computer simulates or implements a human learning behavior to obtain new knowledge or skills, and reorganize an existing knowledge structure, to keep improving performance of the computer. The machine learning is the core of the AI, is a basic way to make the computer intelligent, and is applied to various fields of AI. The machine learning and deep learning generally include technologies such as an artificial neural network, a belief network, reinforcement learning, transfer learning, inductive learning, and learning from demonstrations.

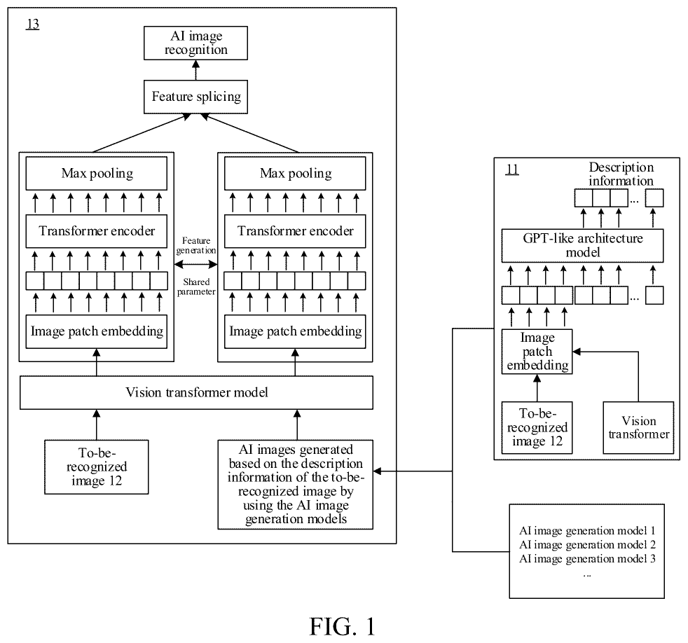

FIG. 1 is a schematic diagram of a machine-generated image recognition method according to an embodiment of the present disclosure. As shown in FIG. 1, the method includes the following operations.

1. Description information of a target image to be recognized 12 is generated by using a description information generation model 11.

2. Machine-generated images respectively corresponding to N image generation manners are generated based on the description information of the target image 12 in a plurality of image generation manners. N is a positive integer greater than 1.

3. Contrastive recognition is respectively performed on the machine-generated images that are respectively corresponding to the N image generation manners and are generated based on the description information of the target image 12 and the target image 12 by using a contrastive recognition model 13, to obtain probabilities that the target image 12 is generated in the image generation manners respectively.

4. In response to that a maximum probability in the probabilities respectively corresponding to the image generation manners is greater than or equal to a threshold, it is determined that the target image 12 is the machine-generated image; and in response to that the maximum probability in the probabilities respectively corresponding to the image generation manners is less than the threshold, it is determined that the target image 12 is not the machine-generated image.

To be specific, the description information generation model 11 includes a vision transformer (ViT), an image patch embedding layer, and a language architecture model. A feature of the target image 12 is obtained after the target image 12 passes the vision transformer and the image patch embedding layer; and the language architecture model generates the description information of the target image 12 based on the feature of the target image 12. In response to that an input of the description information generation model 11 is an image, and an output of the description information generation model 11 is text information (namely, description information in a form of text), the description information generation model 11 may be referred to as an image-to-text generation model. In some embodiments, the language architecture model may be an autoregressive language model, and the model generates text similar to a human language by using deep learning. In a common explanation, the language architecture model is a computer program that continuously learns and autonomously completes text-related work, and does not require an operation of an outside person in a learning process. The language architecture model may be a neural network model similar to a generative pre-trained language model, and may generate corresponding text information based on inputted information (for example, the target image).

Then, an image is generated by using an image generation model 1 based on the description information, an image is generated by using an image generation model 2 based on the description information, and an image is generated by using an image generation model 3 based on the description information.

Next, the images respectively generated by the plurality of image generation models and the target image 12 are inputted into a vision transformer model in the contrastive recognition model 13. Through output of the vision transformer model, the target image may be inputted into an image patch embedding layer, a transformer encoder, and a max pooling layer, to obtain a feature map of the target image. Through the output of the vision transformer model, the generated images may be inputted into the image patch embedding layer, the transformer encoder, and the max pooling layer, to obtain feature maps of the generated images. Subsequently, the feature map of the target image, and the feature maps of the machine-generated images respectively generated in the image generation manners are spliced. In addition, contrastive recognition is performed based on the respective feature maps, to obtain first probability values respectively corresponding to the plurality of image generation models.

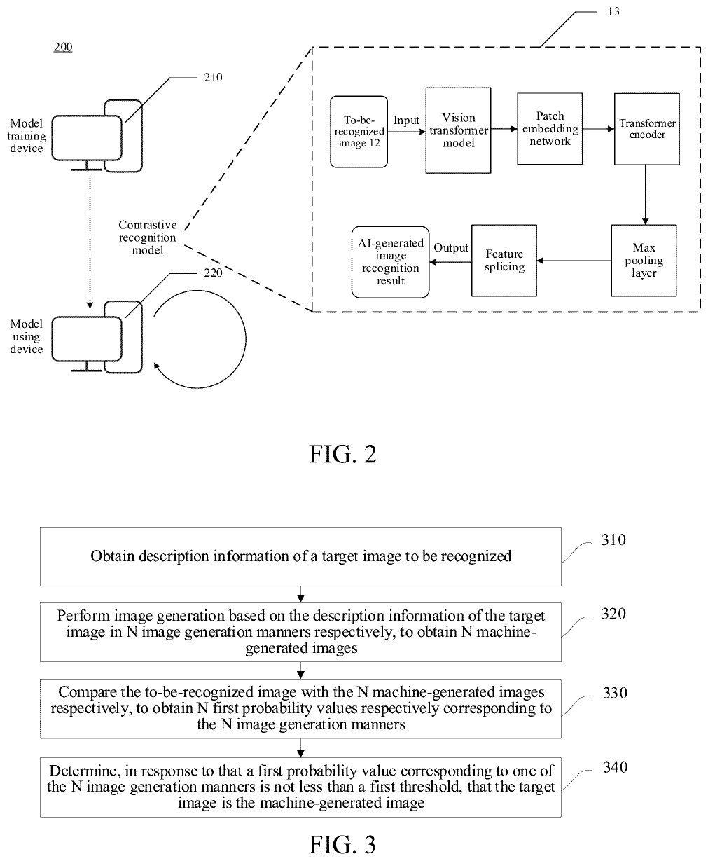

FIG. 2 is a schematic diagram of an implementation environment according to an embodiment of the present disclosure. The implementation environment may be implemented as a machine-generated image recognition system. As shown in FIG. 2, a system 200 may include: a model training device 210 and a model using device 220.

In some embodiments, the model training device 210 is a terminal device. The terminal device is an electronic device having data computation, processing, and storage capabilities. The terminal device may be a personal computer, a tablet computer, a smartphone, a wearable device, a smart robot, an intelligent voice interaction device, a smart home appliance, an in-vehicle terminal, an aircraft, a medical device, or the like, or may be a server. This is not limited in the present disclosure. The model training device 210 is configured to train a contrastive recognition model 13. In the embodiments of the present disclosure, the contrastive recognition model 13 is a neural network model configured to determine whether a target image to be recognized is a machine-generated image. The model training device 210 may train the contrastive recognition model 13 by machine learning, to cause the contrastive recognition model 13 to have good performance.

The completely trained contrastive recognition model 13 may be deployed in the model using device 220 for use, to provide a recognition result (which indicates whether the target image is a machine-generated image) of the target image. The model using device 220 may be a terminal device such as a personal computer (PC), a tablet computer, a smartphone, a wearable device, a smart robot, an intelligent voice interaction device, a smart home appliance, an in-vehicle terminal, an aircraft, or a medical device, or may be a server. This is not limited in the present disclosure.

In a machine-generated image recognition method provided in the embodiments of the present disclosure, each operation may be performed by the model using device 220. In a model training method provided in the embodiments of the present disclosure, each operation may be performed by the model training device 210.

The embodiments of the present disclosure may be applied to various scenarios. For example, whether an image posted by a user on a social platform or a video platform is a machine-generated image may be recognized, to improve operating efficiency of the platform. In some embodiments, prompt information may be added to a recognized machine-generated image, to avoid misleading another user on the platform after browsing the machine-generated image, thereby maintaining an image interaction atmosphere of the platform.

Technical solutions of the present disclosure are described below by using several embodiments.

FIG. 3 is a flowchart of a machine-generated image recognition method according to an embodiment of the present disclosure. In this embodiment, descriptions are made by using an example in which the method is applied to the model using device introduced above. The method may include the following operations (310 to 340).

Operation 310: Obtain description information of a target image to be recognized, the description information of the target image being information configured for describing the target image.

In some embodiments, whether the target image is a machine-generated image generated by a machine needs to be determined.

In some embodiments, a non-machine-generated image is an image photographed by a photographing device, or an image drawn by a person. In some embodiments, the foregoing image drawn by a person may be an physical painting drawn by the person, by using a real painting tool such as a brush or a paint brush, on a painting carrier such as paper, cloth, a wooden board, a wall, leather goods, or a utensil; or may be a digital painting drawn by using an electronic device such as a personal computer, a tablet computer, a mobile phone, a digital tablet, a digital screen, or a virtual reality device; or may be an image manually modified, based on a non-machine-generated image, by using a computer program, for example, an image modified by the person by using an image modification application.

In some embodiments, the machine-generated image is neither an image photographed directly by a photographic device nor an image drawn by a person, but rather an image autonomously generated by an electronic device.

In some embodiments, the machine-generated image includes an AI image generated by an AI image generation model, and each AI image generation model is an image generation manner. In some embodiments, the AI image generation model is a neural network model that can automatically generate an image based on inputted information. In some embodiments, the AI image generation model may be an existing AI image generation model, such as a diffusion model, Dream by WOMBO, a Fotor AI Image Generator, Craiyon, or a Deep Dream Generator.

In some embodiments, the machine-generated image includes an image automatically generated by an application according to a set image generation rule. For example, a set image generation rule of a specific application is performing deformation processing simulating concave mirror imaging on each inputted image, to change a form of an image element in an original image, so that the image element in the original image is like imagining of a normal object in a concave mirror.

In some embodiments, the description information of the target image is configured for describing an image parameter, an image style, image content, a visual angle, and the like of the target image. In some embodiments, the image parameter may include a size, a pixel, a shape, a format, a shooting angle (for example, a top-down shot, a low angle shot, a wide-angle shot, a close-up, macro photographing, or microscopic photographing), and the like of the image. In some embodiments, the image style includes photography (such as documentary (news) photography, document photography, scientific photography, lifestyle photography, nature photography, or portrait photography), painting (such as sketching, oil painting, Chinese painting, watercolor painting, gouache painting, ink wash painting, or digital painting), and the like. In some embodiments, the image style may be further classified into a fresh style, an artistic style, an intimate style, a fashion style, a black-and-white style, and the like. In some embodiments, the image content includes element content, such as a grassland, a blue sky, a white cloud, a little girl, a flower, a lawn, a villa, a lake, a car, knitting, playing, playing football, or shooting at goal, displayed in the target image. In some embodiments, the visual angle may include a high-angle view, a side view, a low-angle view, an eye-level view, a wide angle, a close-up, and the like. In some embodiments, the description information of the target image may be in a form of pure text, or the description information may be red-yellow-blue three channel values (for example, red-yellow-blue three channel values based on a main color or a plurality of main colors in the target image), or the description information may be information in a form of an image, or the description information may be information in a form of sound (for example, style-matching music generated based on the image content and an atmosphere of the target image) or the like. This is not specifically limited in the embodiments of the present disclosure.

In some embodiments, the description information of the target image is generated by using a description information generation model. The description information generation model is a machine learning model that is constructed based on a neural network and is configured to generate description information of an image. The target image is inputted into the description information generation model, and then the description information generation model generates and outputs the description information of the target image.

In some embodiments, as shown in FIG. 1, the description information generation model 11 includes the vision transformer (ViT), the image patch embedding layer, and the language architecture model. The feature of the target image 12 is obtained after the target image 12 passes the vision transformer and the image patch embedding layer; and a GPT-like architecture model generates the description information of the target image 12 based on the feature of the target image 12. In the case that the input of the description information generation model 11 is an image, and the output of the description information generation model 11 is text information (namely, description information in a form of text), the description information generation model 11 may be referred to as the image-to-text generation model. In some embodiments, the language architecture model is an autoregressive language model, and the model generates text similar to a human language by using deep learning. In a common explanation, the language architecture model is a computer program that continuously learns and autonomously completes text-related work, and does not require an operation of an outside person in a learning process. The GPT-like architecture model may be a neural network model similar to a GPT, and may generate corresponding text information based on inputted information (for example, the target image).

Operation 320: Perform image generation based on the description information of the target image in N image generation manners respectively, to obtain N machine-generated images, N being a positive integer.

In some embodiments, the description information of the target image is inputted in the N image generation manners respectively, and one or more machine-generated images are generated in each image generation manner based on the description information of the target image, to obtain machine-generated images that are the same as or similar to the target image in one or more aspects. For example, if the target image includes elements such as a blue sky, a white cloud, and a grassland, the description information of the target image may be “blue sky+white cloud+grassland”, and the machine-generated images may be respectively generated in the image generation manners based on the description information of “blue sky+white cloud+grassland”. The machine-generated image generated in the image generation manner also includes the elements such as a blue sky, a white cloud, and a grassland.

In some embodiments, one or more corresponding machine-generated images may be generated in one image generation manner based on the description information of the target image.

In some embodiments, the performing image generation based on the description information of the target image in N image generation manners respectively, to obtain N machine-generated images in operation 320 may be implemented by using the following technical solutions: performing image generation based on the description information of the target image by using N image generation models respectively, to obtain the N machine-generated images. Any two image generation models of the N image generation models satisfy at least one of the following conditions: model structures of the two image generation models are different; training data sets of the two image generation models are different; or model parameters of the two image generation models are different. The machine-generated images generated by the N image generation models may be covered in the embodiments of the present disclosure, to avoid subsequent missing recognition and improve recognition accuracy.

As an example, the N image generation manners herein are actually N image generation models, namely, the AI image generation models described in the present disclosure. The N image generation models are different in at least model structures, model parameters, and training data sets. For a difference in model structures, the image generation model herein may be a diffusion model, or the image generation model may be a generative adversarial network. In other words, two image generation models may have different model structures. Alternatively, both an image generation model A and an image generation model B are diffusion models, but due to a difference in a quantity of times of iterative training, a parameter of each layer of model structure is different. Therefore, this belongs to a case of a difference in model parameters. Alternatively, both an image generation model A and an image generation model B are diffusion models, but due to a difference in training data sets, this belongs to a case that training data sets of two image generation models are different.

Operation 330: Compare the target image with the N machine-generated images respectively, to obtain first probability values respectively corresponding to the N image generation manners.

The first probability value indicates a probability that the target image is generated in the corresponding image generation manner.

In some embodiments, referring to FIG. 1, after the target image and the machine-generated images respectively generated in the N image generation manners are inputted into the contrastive recognition model, through the vision transformer model (a structure of the vision transformer model is the same as a structure of a vision transformer model in the related art, and a parameter is determined based on a training process of the contrastive recognition model involved in this embodiment of the present disclosure), the image patch embedding layer (a structure of the image patch embedding layer is the same as a structure of an image patch embedding layer in the related art, and a parameter is determined based on the training process of the contrastive recognition model involved in this embodiment of the present disclosure), the transformer encoder (a structure of the transformer encoder is the same as a structure of a transformer encoder in the related art, and a parameter is determined based on the training process of the contrastive recognition model involved in this embodiment of the present disclosure), and the max pooling layer (a structure of the max pooling layer is the same as a structure of a max pooling layer in the related art, and a parameter is determined based on the training process of the contrastive recognition model involved in this embodiment of the present disclosure), the feature map of the target image and the feature maps of the machine-generated images respectively generated in the N image generation manners are obtained. Subsequently, the feature map of the target image, and the feature maps of the machine-generated images are spliced, and a feature map obtained through splicing is mapped (implemented by a fully connected layer), to obtain the first probability values respectively corresponding to the N image generation manners. In some embodiments, the contrastive recognition model is a machine learning model constructed based on a neural network, and is configured to determine whether two images are generated in the same image generation manner. After two images are inputted into the contrastive recognition model, the contrastive recognition model outputs a probability that the two images are generated in the same image generation manner.

In some embodiments, a first probability value corresponding to a target image generation manner is positively correlated with a probability that the target image is generated in the target image generation manner. In other words, a higher probability that the target image is generated in the target image generation manner indicates a higher first probability value; and a lower probability that the target image is generated in the target image generation manner indicates a lower first probability value. In some embodiments, the first probability value corresponding to the target image generation manner is a value of the probability that the target image is generated in the target image generation manner, a value range of the first probability value is between 0 and 1, and the target image generation manner herein is any one of the foregoing N image generation manners.

In some embodiments, the first probability value may alternatively indicate a probability that the target image is not generated in the corresponding image generation manner. In other words, the first probability value corresponding to the target image generation manner may alternatively be configured for indicating a probability that the target image is not generated in the target image generation manner, and the first probability value corresponding to the target image generation manner is negatively correlated with the probability that the target image is generated in the target image generation manner. In other words, a higher probability that the target image is generated in the target image generation manner indicates a lower first probability value; and a lower probability that the target image is generated in the target image generation manner indicates a higher first probability value. In some embodiments, the first probability value corresponding to the target image generation manner is an inverse value of the probability that the target image is generated in the target image generation manner, the first probability value is a positive number, and the target image generation manner herein is any one of the foregoing N image generation manners.

Operation 340: Determine, in response to that a first probability value corresponding to one of the N image generation manners is not less than a first threshold, that the target image is the machine-generated image.

Because the first probability value corresponding to the target image generation manner can reflect the probability that the target image is generated in the target image generation manner, whether the target image is the machine-generated image may be determined based on the first probability value. The target image generation manner herein is any one of the foregoing N image generation manners.

In some embodiments, if the first probability value corresponding to the target image generation manner is positively correlated with the probability that the target image is generated in the target image generation manner, in response to that the first probability value is greater than or equal to the first threshold, it is determined that the target image is the machine-generated image; or in response to that the first probability value is less than the first threshold, it is determined that the target image is not the machine-generated image. The target image generation manner herein is any one of the foregoing N image generation manners.

In some embodiments, the first probability value may alternatively indicate the probability that the target image is not generated in the corresponding image generation manner. In other words, the first probability value corresponding to the target image generation manner may alternatively be configured for indicating the probability that the target image is not generated in the target image generation manner, and the first probability value corresponding to the target image generation manner is negatively correlated with the probability that the target image is generated in the target image generation manner. If the first probability value corresponding to the target image generation manner is negatively correlated with the probability that the target image is generated in the target image generation manner, in response to that the first probability value is less than or equal to a second threshold (in other words, in response to that a first condition is satisfied), it is determined that the target image is the machine-generated image; and in response to that the first probability value is not less than the second threshold (in other words, in response to that the first condition is not satisfied), it is determined that the target image is not the machine-generated image. The target image generation manner herein is any one of the foregoing N image generation manners.

Specific values of the foregoing first threshold and the second threshold may be set according to an actual situation. This is not specifically limited in the embodiments of the present disclosure.

In conclusion, according to the technical solutions provided in the embodiments of the present disclosure, the machine-generated image is generated in the image generation manner by using the description information of the target image, and then contrastive recognition is performed on the target image and the machine-generated images generated in the image generation manners, to determine the probability that the target image is the machine-generated image generated in the image generation manner, so that whether the target image is the machine-generated image can be determined. Because machine-generated images generated in a same image generation manner have a similarity, contrastive recognition is performed by using a reversely generated machine-generated image, to better determine whether the target image is the machine-generated image, thereby increasing an accuracy rate of recognition for the machine-generated image.

In some embodiments, the comparing the target image with the N machine-generated images respectively, to obtain first probability values respectively corresponding to the N image generation manners in the foregoing operation 330 may be implemented by using the following technical solutions: performing the following processing for each image generation manner: performing the following processing by using a contrastive recognition model: determining a first probability value corresponding to the image generation manner based on the target image and a machine-generated image generated in the image generation manner. Through a process in which the foregoing contrastive processing is completed by using the contrastive recognition model in the embodiments of the present disclosure, an artificial intelligence model technology can be applied to contrastive recognition, to improve recognition accuracy.

As an example, the first probability values corresponding to various image generation manners are determined by using the contrastive recognition model. For example, by using the contrastive recognition model, contrastive recognition is performed on the target image and a machine-generated image generated in the target image generation manner, to determine the first probability value corresponding to the target image generation manner. The target image generation manner is any one of the N image generation manners.

In some embodiments, the performing the following processing by using a contrastive recognition model: determining a first probability value corresponding to the image generation manner based on the target image and a machine-generated image generated in the image generation manner may be implemented by using the following technical solutions: using the target image and one machine-generated image generated in the image generation manner as an input of the contrastive recognition model, outputting a first probability value by using the contrastive recognition model, and determining the first probability value as the first probability value corresponding to the image generation manner. In this way, the first probability value can intuitively and accurately represent a possibility that the target image is generated in the target image generation manner, and there is no need to perform computation and integration on the output of the contrastive recognition model, to improve computing resource utilization.

In some embodiments, the performing the following processing by using a contrastive recognition model: determining a first probability value corresponding to the image generation manner based on the target image and a machine-generated image generated in the image generation manner may be implemented by using the following technical solutions: using a plurality of image pairs as an input of the contrastive recognition model, outputting second probability values respectively corresponding to the plurality of image pairs by using the contrastive recognition model, and determining the first probability value corresponding to the image generation manner based on the second probability values respectively corresponding to the plurality of image pairs. A plurality of machine-generated images are generated in the image generation manner, and each of the image pairs includes the target image and one machine-generated image generated in the image generation manner.

As an example, in response to that a plurality of machine-generated images are generated in the target image generation manner, contrastive recognition is respectively performed on the plurality of machine-generated images generated in the target image generation manner and the target image by using the contrastive recognition model, to obtain the second probability values respectively corresponding to the plurality of image pairs; and a mean value, a maximum value, or a median value of the second probability values respectively corresponding to the plurality of image pairs is determined as the first probability value corresponding to the target image generation manner. The target image generation manner is any one of the foregoing N image generation manners. For a specific image generation manner, a plurality of machine-generated images are generated and are respectively compared with the target image to obtain a plurality of second probability values, and a first probability value corresponding to the image generation manner is obtained based on the plurality of second probability values. In this way, an error of the first probability value corresponding to the image generation manner can be reduced, to increase an accuracy rate of the first probability value, thereby increasing a recognition accuracy rate of the contrastive recognition model.

In the foregoing embodiment, first probability values corresponding to various image generation manners are determined by using the contrastive recognition model, and the first probability value can intuitively and accurately represent the possibility that the target image is generated in the target image generation manner, thereby increasing the recognition accuracy rate of the contrastive recognition model. In addition, in a manner in which a plurality of machine-generated images are generated in one image generation manner, and a mean value of first probability values respectively corresponding to the plurality of machine-generated images is obtained, an accuracy rate of an obtained first probability value corresponding to the image generation manner is increased, thereby further increasing the recognition accuracy rate of the contrastive recognition model.

In some embodiments, after operation 320 is performed, the target image is classified by using a classification model, to obtain a third probability value of the target image. The third probability value indicates a probability that the target image is the machine-generated image; and in response to that the third probability value and the first probability values respectively corresponding to the N image generation manners satisfy a second condition, it is determined that the target image is the machine-generated image. In the embodiments of the present disclosure, whether the target image is the machine-generated image may be jointly determined by using a classification result and a recognition result, so that determining accuracy for the target image can be improved.

As an example, the classification model is a model constructed based on a neural network, and the classification model is configured for classifying and recognizing whether the target image is the machine-generated image, or which AI image generation model specifically generates the target image. The target image is inputted into the classification model, and the classification model outputs the probability that the image is the machine-generated image, or the classification model outputs probabilities that the image is generated in the image generation manners respectively and a probability that the image is a non-machine-generated image.

As an example, the classification model is a binary classification model, namely, a model that can obtain only two classification results. For example, for the classification result of the classification model in the embodiments of the present disclosure, only two classification results may be outputted: the target image is the machine-generated image, and the target image is not the machine-generated image. The third probability value may be configured for representing a probability or possibility that the target image is the machine-generated image. In some embodiments, if the third probability value is greater than or equal to a third threshold, the classification result of the classification model is that the target image is the machine-generated image; and if the third probability value is less than the third threshold, the classification result of the classification model is that the target image is not the machine-generated image. In some embodiments, in response to that the first probability value is a probability value indicating that the target image is the machine-generated image, the third threshold is greater than or equal to 0.5, for example, 0.5, 0.55, 0.6, 0.7, or 0.8. A specific value of the third threshold may be set according to an actual situation. This is not specifically limited in the embodiments of the present disclosure.

In some embodiments, that the target image is classified by using the classification model, to obtain the third probability value of the target image may be implemented by using the following technical solutions: classifying the target image by using the classification model, to obtain N fourth probability values, the N fourth probability values indicating probabilities that the target image is generated in the N image generation manners respectively; performing summation on the N fourth probability values, to obtain a summation result of the N fourth probability values; and determining the third probability value based on the summation result of the N fourth probability values. In the embodiments of the present disclosure, from a perspective of classification, the N fourth probability values corresponding to the N image generation manners may be obtained. Different from the foregoing that both the target image and the machine-generated image are inputted into the contrastive recognition model, whether the target image is generated based on the foregoing N image generation manners is directly determined for the target image. In other words, a relationship between the target image and the image generation manner is determined from different perspectives, to improve determining accuracy. Then, fusion processing is performed on the N fourth probability values corresponding to the N image generation manners, so that the third probability value indicating that the target image is the machine-generated image may be obtained from the whole, to improve determining accuracy.

As an example, the target image is inputted into the classification model, and the classification model may output N+1 fourth probability values. Previous N fourth probability values of the N+1 fourth probability values are respectively configured for indicating probabilities that the target image is generated in the N image generation manners respectively; and an (N+1)^{th} fourth probability value of the N+1 fourth probability values indicates a probability that the target image is not the machine-generated image.

As an example, N represents a quantity of AI image generation models participating in recognition, and N is an integer greater than or equal to 2. The classification model is a multi-classification model. In other words, a quantity (namely, N+1) of classification results of the classification model is greater than 2. A third probability value (which may be represented as P_cls_sum) obtained through summation performed on the previous N fourth probability values of the N+1 fourth probability values may be configured for representing the probability, obtained by using the classification model, that the target image is the machine-generated image.

In some embodiments, the third probability value obtained by the multi-classification model, and the first probability values that are respectively corresponding to the N image generation manners and are obtained by using the contrastive recognition model are combined. In this way, whether the target image is the machine-generated image may be comprehensively determined.

In some embodiments, that in response to that the third probability value and the first probability values respectively corresponding to the N image generation manners satisfy the second condition, it is determined that the target image is the machine-generated image may be implemented by using the following technical solutions: obtaining an extremum value in the first probability values respectively corresponding to the N image generation manners, the extremum value being a maximum value or a minimum value; determining a combined probability value based on the extremum value and the third probability value; and determining, in response to that the combined probability value is greater than or equal to a threshold, that the target image is the machine-generated image.

As an example, the second condition is that the combined probability value is greater than or equal to the threshold. The threshold may be set according to a requirement of recognition accuracy.

As an example, in response to that a first probability value corresponding to an image generation manner is positively correlated with a probability that the target image is generated in the image generation manner, the extremum value is a maximum value (which may be represented as P_sam_max) in the first probability values respectively corresponding to the N image generation manners. In response to that a first probability value corresponding to an image generation manner is negatively correlated with a probability that the target image is generated in the image generation manner, the extremum value is a minimum value in the first probability values respectively corresponding to the N image generation manners.

As an example, if the foregoing extremum value is a maximum value, direct summation or weighted summation may be performed on the third probability value and the extremum value, to obtain the combined probability value. In some embodiments, the combined probability value may be represented as P_AI. Refer to Formula (1):

$$P\_AI = Weight\_ 1 * P\_cls \_sum + Weight\_ 2 * P\_sam \_max \qquad ( 1 )$$

Weight_1 is a weight of the third probability value, and Weight_2 is a weight of the extremum value. In some embodiments, a sum of Weight_1 and Weight_2 is equal to 1, and Weight_2 is greater than Weight_1. For example, Weight_1 is equal to 0.2, and Weight_2 is equal to 0.8. Certainly, specific values of Weight_1 and Weight_2 may be set according to an actual situation. This is not specifically limited in the embodiments of the present disclosure.

In the foregoing embodiment, the extremum value in the first probability values respectively corresponding to the N image generation manners and the third probability value are combined to obtain the combined probability value. In this way, respective recognition results of the contrastive recognition model and the classification model are combined for comprehensive consideration. Based on this, a final determining result of whether the target image is the machine-generated image is more accurate, thereby increasing an accuracy rate of recognition for the machine-generated image.

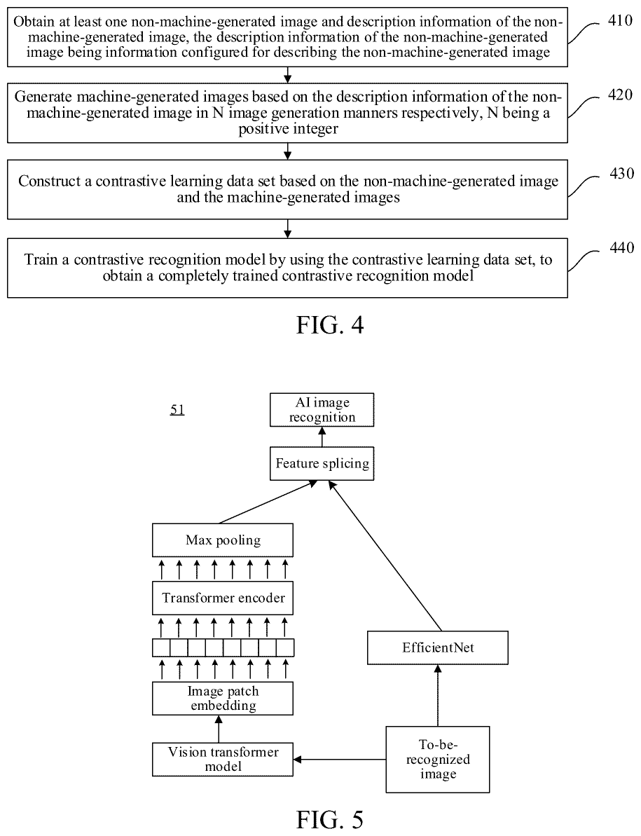

FIG. 4 is a flowchart of a model training method according to an embodiment of the present disclosure. In this embodiment, descriptions are made by using an example in which the method is applied to the model training device introduced above. The method may include the following operations (410 to 440):

Operation 410: Obtain at least one non-machine-generated image and description information of the non-machine-generated image, the description information of the non-machine-generated image being information configured for describing the non-machine-generated image.

In some embodiments, the non-machine-generated image is an image naturally generated, instead of an image generated in an image generation manner. For example, the non-machine-generated image is an image photographed by a photographing device, or an image drawn by a person.

For related content of the description information of the non-machine-generated image, reference may be made to the content in operation 310 in the foregoing embodiment in FIG. 3. Details are not described herein again.

In some embodiments, the description information of the non-machine-generated image is generated by using a description information generation model. In some embodiments, the description information generation model is obtained through pre-training by using a sample image manually marked with description information.

Operation 420: Perform image generation based on the description information of the non-machine-generated image in N image generation manners respectively, to obtain machine-generated images, N being a positive integer.

Operation 430: Construct a contrastive learning data set based on the non-machine-generated image and the machine-generated images.

In some embodiments, the contrastive learning data set includes at least one positive sample pair and at least one negative sample pair, each positive sample pair includes two machine-generated images generated based on description information of a same non-machine-generated image in a same image generation manner, and each negative sample pair includes two machine-generated images generated based on description information of a same non-machine-generated image in different image generation manners.

As an example, the following machine-generated images may be generated based on a non-machine-generated image Img_1: an image Img_1_M1_1: an image 1 randomly generated based on description information of the Img_1 in an image generation manner 1; an image Img_1_M1_2: an image 2 randomly generated based on the description information of the Img_1 in the image generation manner 1; an image Img_1_M2_1: an image 1 randomly generated based on the description information of the Img_1 in an image generation manner 2; an image Img_1_M2_2: an image 2 randomly generated based on the description information of the Img_1 in the image generation manner 2; and the like, which may be represented as: an image Img_1_Mk_1: an image 1 randomly generated based on the description information of the Img_1 in an image generation manner k; and an image Img_1_Mk_2: an image 2 randomly generated based on the description information of the Img_1 in the image generation manner k.

As an example, the positive sample pair in the contrastive learning data set may include: the image Img_1_M1_1: the image 1 randomly generated based on the description information of the Img_1 in the image generation manner 1; and the image Img_1_M1_2: the image 2 randomly generated based on the description information of the Img_1 in the image generation manner 1.

As an example, the negative sample pair in the contrastive learning data set may include: the image Img_1_M1_1: the image 1 randomly generated based on the description information of the Img_1 in an image generation manner 1; and the image Img_1_M2_1: the image 1 randomly generated based on the description information of the Img_1 in the image generation manner 2.

Operation 440: Train a contrastive recognition model by using the contrastive learning data set, to obtain a completely trained contrastive recognition model.

In some embodiments, during training, the contrastive recognition model is configured to perform contrastive recognition on two images in an inputted sample pair, to determine whether the two images in the sample pair are generated in a same image generation manner, and adjust a parameter of the contrastive recognition model based on a determining result.

In some embodiments, two images in a sample pair inputted into the contrastive recognition model are computed, a loss of the contrastive recognition model is constructed by using a pre-distance between features generated in the contrastive recognition model, a loss for contrastive recognition is positively correlated with the pre-distance, and a parameter of the contrastive recognition model is adjusted based on the loss.

As an example, the completely trained contrastive recognition model is configured to compare a target image to be recognized with N machine-generated images respectively, to obtain a first probability value indicating that the target image and any one of the N machine-generated images are generated in a same image generation manner, the N machine-generated images being generated based on description information of the target image in the N image generation manners respectively.

In conclusion, in the technical solutions provided in the embodiments of the present disclosure, the machine-generated images are generated based on the description information of the non-machine-generated image in the image generation manner, then the contrastive learning data set is constructed by using the machine-generated images whose image generation manners are determined, and the contrastive recognition model is trained based on the contrastive learning data set, so that the completely trained contrastive recognition model can determine whether the target image is the machine-generated image by comparing inputted images (the target image and a machine-generated image generated in a specific image generation manner), thereby increasing an accuracy rate of recognition for the machine-generated image.

In some embodiments, a classification data set is constructed based on the non-machine-generated image and a sample machine-generated image, the classification data set including at least one training sample, and each training sample being a non-machine-generated image or a sample machine-generated image. A classification model trained is by using the classification data set, to obtain a completely trained classification model. The completely trained classification model is configured to output a third probability value indicating that the target image is the machine-generated image, and the third probability value is configured for being combined with the first probability value to determine whether the target image is the machine-generated image. In the embodiments of the present disclosure, the classification model is trained by using the classification data set, so that the classification model has a specific capability of determining whether the target image is the machine-generated image.

In some embodiments, that a classification model trained is by using the classification data set, to obtain a completely trained classification model may be implemented by using the following technical solutions: First-stage training is performed on the classification model by using the classification data set, to obtain a trained classification model. Second-stage training is performed on the classification model by using the machine-generated image, to obtain the completely trained classification model.

In some embodiments, the classification model is configured to predict a probability that an inputted image is generated in each image generation manner and a probability that the inputted image is not the machine-generated image.

As an example, in a process in which the first-stage training is performed on the classification model, an image in the used classification data set may be obtained by taking a screenshot from a movie, a drama, or a short video in a standard and legal manner, may be obtained from an encyclopedia webpage, may be obtained through autonomous photographing, or may be randomly generated in an image generation manner based on an existing non-machine-generated image. In the embodiments of the present disclosure, in the process in which the first-stage training is performed on the classification model, a source and obtaining manner of the image in the used classification data set are not specifically limited. After the first-stage training is completed, the classification model initially has a specific capability of recognizing the machine-generated image.

As an example, in response to that the classification model is a multi-classification model (namely, the foregoing classification model that can output N+1 second probability values), after the classification model completes the first-stage training, the second-stage training is performed on the classification model by using the machine-generated image generated based on the description information of the non-machine-generated image in the foregoing N machine-generated images. Because sources of the machine-generated images used in the second-stage training are clear, in other words, image generation manners corresponding to the machine-generated images used in the second-stage training are known and determined, the classification model may be enabled to learn features of the machine-generated images generated in the image generation manners.

As an example, as shown in FIG. 5, a classification model 51 may include a vision transformer model, an image patch embedding layer, a transformer encoder, a max pooling layer, EfficientNet and a feature splicing layer. A feature of the target image obtained through the vision transformer model, the image patch embedding layer, the transformer encoder, and the max pooling layer, and a feature of the target image obtained through the EfficientNet are spliced on the feature splicing layer, and then probabilities that the target image is generated in various image generation manners and a probability that the target image is a non-machine-generated image are determined.

In the foregoing embodiment, multi-stage training is performed on the classification model, so that before the second-stage training, the classification model initially has a certain capability of recognizing a machine-generated image. In this way, a quantity of samples and/or training time required in the second-stage training can be reduced, to improve training efficiency of the classification model.

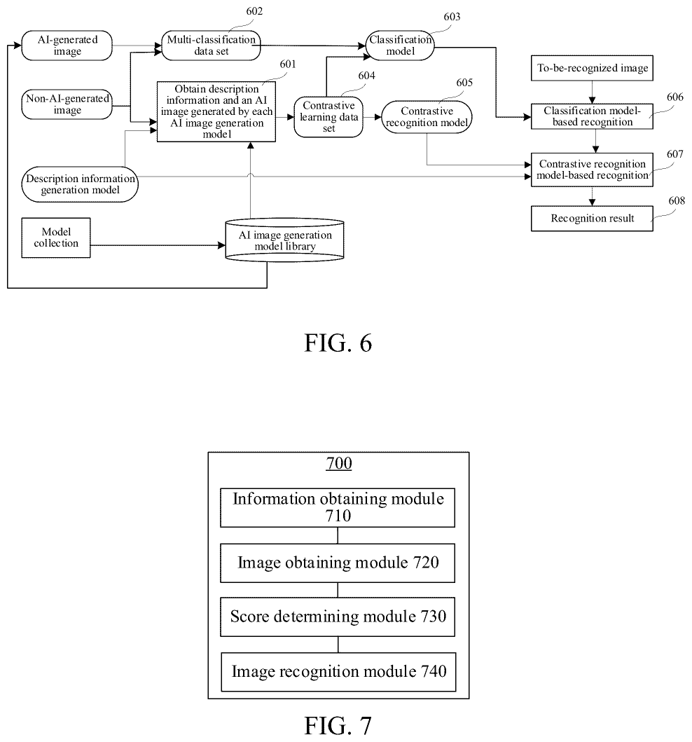

In some embodiments, as shown in FIG. 6, that a machine-generated image is an AI-generated image, and an image generation manner is an AI image generation model is used as an example. A machine-generated image recognition method and a model training method may include the following operations (601 to 608).

Operation 601: Obtain description information of a non-AI-generated image, and generate, based on the description information of the non-AI-generated image, an AI image corresponding to each AI image generation model by using an AI image generation model in an AI image generation model library.

Operation 602: Construct a multi-classification data set.

Operation 603: Train a classification model based on the multi-classification data set, to obtain a completely trained classification model.

Operation 604: Construct a contrastive learning data set based on the AI image corresponding to each AI image generation model.

Operation 605: Train a contrastive recognition model based on the contrastive learning data set, to obtain a completely trained contrastive recognition model.

Operation 606: Obtain a classification result of a target image to be recognized based on the classification model.

Operation 607: Obtain, based on the contrastive recognition model, a comparison result between the target image and AI images respectively generated by N AI image generation models.

Operation 608: With reference to the classification result of the target image obtained by the classification model, and the comparison result between the target image and the AI images respectively generated by the N AI image generation models, generate and output a recognition result of whether the target image is an AI-generated image.

In the present disclosure, when implementation of an involved data crawling technical solution in the foregoing embodiment of the present disclosure is applied to a specific product or technology, relevant data collection, use, and processing processes are to comply with requirements of national laws and regulations, comply with a principle of legality, legitimacy, and necessity, not involve obtaining of a data type prohibited or restricted by the laws and regulations, and not hinder normal operation of a target website.

In the embodiments of the present disclosure, related data such as an object resource transfer behavior is involved. When the embodiments of the present disclosure are applied to a specific product or technology, permission or consent of an object is required to be obtained, and collection, use, and processing of the related data are required to comply with relevant laws, regulations, and standards of relevant countries and regions.

The following is an apparatus embodiment of the present disclosure, which can be used to perform the method embodiments of the present disclosure. For details not disclosed in the apparatus embodiment of the present disclosure, reference may be made to the method embodiments of the present disclosure.

FIG. 7 is a block diagram of a machine-generated image recognition apparatus according to an embodiment of the present disclosure. An apparatus 700 may include: an information obtaining module 710, an image obtaining module 720, a score determining module 730, and an image recognition module 740. The information obtaining module 710 is configured to obtain description information of a target image to be recognized, the description information of the target image being information configured for describing content of the target image. The image obtaining module 720 is configured to perform image generation based on the description information of the target image in N image generation manners respectively, to obtain N machine-generated images, N being a positive integer. The score determining module 730 is configured to compare the target image with the N machine-generated images respectively, to obtain first probability values respectively corresponding to the N image generation manners, the first probability value indicating a probability that the target image is generated in the corresponding image generation manner. The image recognition module 740 is configured to determine, in response to that a first probability value corresponding to one of the N image generation manners is not less than a first threshold, that the target image is the machine-generated image.

In some embodiments, the image obtaining module 720 is configured to perform image generation based on the description information of the target image by using N image generation models respectively, to obtain the N machine-generated images, any two image generation models of the N image generation models satisfying at least one of the following conditions: model structures of the two image generation models are different; training data sets of the two image generation models are different; or model parameters of the two image generation models are different.

In some embodiments, the score determining module 730 is configured to performing the following processing for each of the image generation manners: performing the following processing by using a contrastive recognition model: determining a first probability value corresponding to the image generation manner based on the target image and a machine-generated image generated in the image generation manner.

In some embodiments, the score determining module 730 is configured to: use the target image and one machine-generated image generated in the image generation manner as an input of the contrastive recognition model, output a first probability value by using the contrastive recognition model, and use the first probability value as the first probability value corresponding to the image generation manner; or use a plurality of image pairs as an input of the contrastive recognition model, output second probability values respectively corresponding to the plurality of image pairs by using the contrastive recognition model, and determine the first probability value corresponding to the image generation manner based on the second probability values respectively corresponding to the plurality of image pairs, a plurality of machine-generated images being generated in the image generation manner, and each of the image pairs including the target image and one machine-generated image generated in the image generation manner.

In some embodiments, the score determining module 730 is further configured to: classify the target image by using a classification model, to obtain a third probability value of the target image, the third probability value indicating a probability that the target image is the machine-generated image; and determine, in response to that the third probability value and the first probability values respectively corresponding to the N image generation manners satisfy a second condition, that the target image is the machine-generated image.

In some embodiments, the score determining module 730 is configured to: classify the target image by using the classification model, to obtain N fourth probability values, the N fourth probability values indicating probabilities that the target image is generated in the N image generation manners respectively; perform summation on the N fourth probability values, to obtain a summation result of the N fourth probability values; and determine the third probability value based on the summation result of the N fourth probability values.

In some embodiments, the score determining module 730 is configured to: obtain an extremum value in the first probability values respectively corresponding to the N image generation manners, the extremum value being a maximum value or a minimum value; determine a combined probability value based on the extremum value and the third probability value; and determine, in response to that the combined probability value is greater than or equal to a threshold, that the target image is the machine-generated image; or determine, in response to that the combined probability value is less than a threshold, that the target image is not the machine-generated image.

In conclusion, according to the technical solutions provided in the embodiments of the present disclosure, a machine-generated image is generated in an image generation manner by using description information of a target image to be recognized, and then contrastive recognition is performed on the target image and machine-generated images generated in some image generation manners, to determine a probability that the target image is the machine-generated image generated in the image generation manners, so that whether the target image is a machine-generated image can be determined. Because machine-generated images generated in a same image generation manner have a similarity, contrastive recognition is performed by using a reversely generated machine-generated image, to better determine whether the target image is a machine-generated image, thereby increasing an accuracy rate of recognition for the machine-generated image.

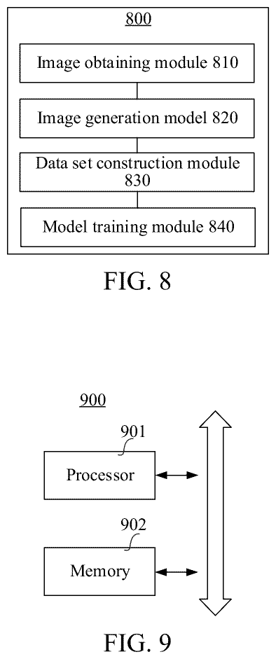

FIG. 8 is a block diagram of a model training apparatus according to an embodiment of the present disclosure. The apparatus 800 may include: an image obtaining module 810, an image generation module 820, a data set construction module 830, and a model training module 840. The image obtaining module 810 is configured to obtain at least one non-machine-generated image and description information of the non-machine-generated image, the description information of the non-machine-generated image being information configured for describing the non-machine-generated image. The image generation module 820 is configured to perform image generation based on the description information of the non-machine-generated image in N image generation manners respectively, to obtain machine-generated images, N being a positive integer. The data set construction module 830 is configured to construct a contrastive learning data set based on the non-machine-generated image and the machine-generated images, the contrastive learning data set including at least one positive sample pair and at least one negative sample pair, each positive sample pair including two machine-generated images generated based on description information of a same non-machine-generated image in a same image generation manner, and each negative sample pair including two machine-generated images generated based on description information of a same non-machine-generated image in different image generation manners. The model training module 840 is configured to train a contrastive recognition model by using the contrastive learning data set, to obtain a completely trained contrastive recognition model, the completely trained contrastive recognition model being configured to compare a target image to be recognized with N machine-generated images respectively, to obtain a first probability value indicating that the target image and any one of the N machine-generated images are generated in a same image generation manner, the N machine-generated images being generated based on description information of the target image in the N image generation manners respectively.

In some embodiments, the data set construction module 830 is further configured to: construct a classification data set based on the non-machine-generated image and a sample machine-generated image, the classification data set including at least one training sample, and each training sample being a non-machine-generated image or a sample machine-generated image; train a classification model by using the classification data set, to obtain a completely trained classification model, the completely trained classification model being configured to output a third probability value indicating that the target image is the machine-generated image, and the third probability value being configured for being combined with the first probability value to determine whether the target image is the machine-generated image.

In some embodiments, the data set construction module 830 is configured to: perform first-stage training on the classification model by using the classification data set, to obtain a trained classification model; and perform second-stage training on the classification model by using the machine-generated image, to obtain the completely trained classification model.

In some embodiments, the classification model is configured to predict a probability that an inputted image is generated in each image generation manner and a probability that the inputted image is not a machine-generated image.

In conclusion, in the technical solutions provided in the embodiments of the present disclosure, the machine-generated images are generated based on the description information of the non-machine-generated image in the image generation manner, then the contrastive learning data set is constructed by using the machine-generated images whose image generation manners are determined, and the contrastive recognition model is trained based on the contrastive learning data set, so that the completely trained contrastive recognition model can determine whether the target image is a machine-generated image by comparing inputted images, thereby increasing an accuracy rate of recognizing whether the target image is a machine-generated image.

When the apparatus provided in the foregoing embodiments implements functions of the apparatus, the division of the foregoing functional modules is merely an example for description. In the practical application, the functions may be assigned to and completed by different functional modules according to the requirements, that is, the internal structure of the device is divided into different functional modules, to implement all or some of the functions described above. The term module (and other similar terms such as submodule, unit, subunit, etc.) in this disclosure may refer to a software module, a hardware module, or a combination thereof. A software module (e.g., computer program) may be developed using a computer programming language. A hardware module may be implemented using processing circuitry and/or memory. Each module can be implemented using one or more processors (or processors and memory). Likewise, a processor (or processors and memory) can be used to implement one or more modules. In addition, the apparatus and method embodiments provided in the foregoing embodiments belong to the same conception. For the specific implementation process, reference may be made to the method embodiments, and details are not described herein again.

FIG. 9 is a block diagram of an electronic device according to an embodiment of the present disclosure. The electronic device may be the model using device introduced above, configured to implement the machine-generated image recognition method according to the foregoing embodiments. Alternatively, the electronic device may be the model training device introduced above, configured to implement the model training method according to the foregoing embodiments.

Generally, an electronic device 900 includes a processor 901 and a memory 902.

The processor 901 may include one or more processing cores, and may be, for example, a 4-core processor or a 6-core processor. The processor 901 may be implemented by using at least one hardware form of digital signal processing (DSP), a field programmable gate array (FPGA), and a programmable logic array (PLA). The processor 901 may alternatively include a main processor and a coprocessor. The main processor is a processor configured to process data in an active state, and is also referred to as a central processing unit (CPU); and the coprocessor is a low-power processor configured to process data in a standby state.

In some embodiments, the processor 901 may be integrated with a graphics processing unit (GPU). The GPU is configured to be responsible for rendering and drawing content that needs to be displayed on a display screen. In some embodiments, the processor 901 may further include an AI processor. The AI processor is configured to process a computing operation related to machine learning. The memory 902 may include one or more computer-readable storage media. The computer-readable storage medium may be tangible and non-transitory. The memory 902 may further include a high-speed random access memory and a non-volatile memory, for example, one or more disk storage devices or flash storage devices. In some embodiments, the non-transitory computer-readable storage medium in the memory 902 has a computer program stored therein, the computer program being loaded and executed by the processor 901 to implement the machine-generated image recognition method according to the foregoing method embodiments, or implement the model training method according to the foregoing method embodiments.

In an exemplary embodiment, a computer-readable storage medium is further provided, having a computer program stored therein, the computer program, when executed by a processor, implementing the foregoing machine-generated image recognition method, or implementing the foregoing model training method.

In some embodiments, the computer-readable storage medium may include: a read-only memory (ROM), a random-access memory (RAM), a solid state drive (SSD), an optical disc, or the like. The RAM may include a resistive RAM (ReRAM) and a dynamic RAM (DRAM).

An embodiment of the present disclosure further provides a computer program product, including a computer program, the computer program being stored in a computer-readable storage medium. A processor of an electronic device reads the computer program from the computer-readable storage medium, and executes the computer program, to cause the electronic device to perform the foregoing machine-generated image recognition method, or perform the foregoing model training method.

In the present disclosure, before collection of relevant data of the user and during the collection of the relevant data of the user, a prompt interface or a pop-up window may be displayed, or audio prompt information may be outputted. The prompt interface, the pop-up window, or the audio prompt information is configured for prompting the user that the relevant data of the user is currently collected. In this way, in the present disclosure, only after a confirmation operation transmitted by the user for the prompt interface or the pop-up window is obtained, a relevant operation of obtaining the relevant data of the user is started to be performed. Otherwise (in other words, the confirmation operation transmitted by the user for the prompt interface or the pop-up window is not obtained), the relevant operation of obtaining the relevant data of the user is ended, in other words, the relevant data of the user is not obtained. In other words, all user data collected in the present disclosure is collected with consent and authorization of the user. In addition, collection, use, and processing of the relevant user data are required to comply with relevant laws, regulations, and standards of relevant countries and regions.

It is to be understood that “plurality of” mentioned in this specification means two or more. And/or describes an association relationship for describing associated objects and represents that three relationships may exist. For example, A and/or B may represent the following three cases: Only A exists, both A and B exist, and only B exists. The character “/” generally indicates an “or” relationship between the associated objects.

The foregoing descriptions are merely exemplary embodiments of the present disclosure, but are not intended to limit the present disclosure. Any modification, equivalent replacement, or improvement made within the spirit and principle of the present disclosure shall fall within the protection scope of the present disclosure.

What is claimed is:

1. A machine-generated image recognition method, performed by an electronic device, the method comprising:
obtaining description information of a target image to be recognized;
performing image generation based on the description information of the target image in N image generation manners respectively, to obtain N machine-generated images, N being a positive integer greater than 1;
comparing the target image with the N machine-generated images respectively, to obtain N first probability values respectively corresponding to the N image generation manners, each of the N first probability values indicating a probability that the target image is generated in the corresponding image generation manner; and
determining, in response to that a first probability value corresponding to one of the N image generation manners is not less than a first threshold, that the target image is the machine-generated image.

2. The method according to claim 1, wherein the performing image generation based on the description information of the target image in N image generation manners respectively, to obtain N machine-generated images comprises:
performing image generation based on the description information of the target image by using N image generation models respectively, to obtain the N machine-generated images,
any two image generation models of the N image generation models satisfying at least one of the following conditions:
model structures of the two image generation models are different;
training data sets of the two image generation models are different; or
model parameters of the two image generation models are different.

3. The method according to claim 1, wherein the comparing the target image with the N machine-generated images respectively, to obtain N first probability values respectively corresponding to the N image generation manners comprises:
for each image generation manner of the N image generation manners:
determining, by using a contrastive recognition model, the first probability value corresponding to the image generation manner based on the target image and a machine-generated image generated in the image generation manner.

4. The method according to claim 3, wherein determining, by using a contrastive recognition model, the first probability value corresponding to the image generation manner based on the target image and a machine-generated image generated in the image generation manner comprises:
using the target image and one machine-generated image generated in the image generation manner as an input of the contrastive recognition model, and outputting the first probability value corresponding to the image generation manner by using the contrastive recognition model.

5. The method according to claim 3, wherein determining, by using a contrastive recognition model, a first probability value corresponding to the image generation manner based on the target image and a machine-generated image generated in the image generation manner comprises:
generating a plurality of machine-generated images in the image generation manner;
establishing a plurality of image pairs, each of the image pairs comprising the target image and one of the plurality of machine-generated images generated in the image generation manner;
inputting the plurality of image pairs to the contrastive recognition model, outputting second probability values respectively corresponding to the plurality of image pairs by using the contrastive recognition model; and
determining the first probability value corresponding to the image generation manner based on the second probability values respectively corresponding to the plurality of image pairs.

6. The method according to claim 1, further comprising:
classifying the target image by using a classification model, to obtain a third probability value of the target image, the third probability value indicating a probability that the target image is the machine-generated image; and
determining, in response to that the third probability value and the N first probability values respectively corresponding to the N image generation manners satisfy a second condition, that the target image is the machine-generated image.

7. The method according to claim 6, wherein the classifying the target image by using a classification model, to obtain a third probability value of the target image comprises:
classifying the target image by using the classification model, to obtain N fourth probability values, each of the N fourth probability values indicating a probability that the target image is generated in one of the N image generation manners respectively;
performing summation on the N fourth probability values, to obtain a summation result of the N fourth probability values; and
determining the third probability value based on the summation result of the N fourth probability values.

8. The method according to claim 6, wherein the determining, in response to that the third probability value and the N first probability values respectively corresponding to the N image generation manners satisfy a second condition, that the target image is the machine-generated image comprises:
obtaining an extremum value in the N first probability values respectively corresponding to the N image generation manners, the extremum value being a maximum value or a minimum value of the N first probability values;
determining a combined probability value based on the extremum value and the third probability value; and
determining, in response to that the combined probability value is greater than or equal to a threshold, that the target image is the machine-generated image.

9. The method according to claim 3, wherein the contrastive recognition model is obtained by:
obtaining at least one non-machine-generated image and description information of the non-machine-generated image;
performing image generation based on the description information of the non-machine-generated image in N image generation manners respectively, to obtain machine-generated images;
constructing a contrastive learning data set based on the non-machine-generated image and the machine-generated images, the contrastive learning data set comprising at least one positive sample pair and at least one negative sample pair, each positive sample pair comprising two machine-generated images generated based on description information of a same non-machine-generated image in a same image generation manner, and each negative sample pair comprising two machine-generated images generated based on description information of a same non-machine-generated image in different image generation manners;
training a contrastive recognition model by using the contrastive learning data set, to obtain the completely trained contrastive recognition model.

10. The method according to claim 6, wherein the classification model is obtained by:
constructing a classification data set based on the non-machine-generated image and a sample machine-generated image, the classification data set comprising at least one training sample, and each training sample being a non-machine-generated image or a sample machine-generated image; and
training the classification model by using the classification data set, to obtain a completely trained classification model.

11. The method according to claim 10, wherein the training the classification model by using the classification data set, to obtain the completely trained classification model comprises:
performing first-stage training on the classification model by using the classification data set, to obtain a trained classification model; and
performing second-stage training on the classification model by using the machine-generated image, to obtain the completely trained classification model.

12. A machine-generated image recognition apparatus, comprising:
a processor and a memory, the memory having a computer program stored therein, and the computer program being loaded and executed by the processor to implement:
obtaining description information of a target image to be recognized;
performing image generation based on the description information of the target image in N image generation manners respectively, to obtain N machine-generated images, N being a positive integer greater than 1;
comparing the target image with the N machine-generated images respectively, to obtain N first probability values respectively corresponding to the N image generation manners, each of the N first probability values indicating a probability that the target image is generated in the corresponding image generation manner; and
determining, in response to that a first probability value corresponding to one of the N image generation manners is not less than a first threshold, that the target image is the machine-generated image.

13. The apparatus according to claim 12, wherein the performing image generation based on the description information of the target image in N image generation manners respectively, to obtain N machine-generated images comprises:
performing image generation based on the description information of the target image by using N image generation models respectively, to obtain the N machine-generated images, any two image generation models of the N image generation models satisfying at least one of the following conditions:
model structures of the two image generation models are different;
training data sets of the two image generation models are different; or
model parameters of the two image generation models are different.

14. The apparatus according to claim 12, wherein the comparing the target image with the N machine-generated images respectively, to obtain N first probability values respectively corresponding to the N image generation manners comprises:
for each image generation manner of the N image generation manners:
determining, by using a contrastive recognition model, the first probability value corresponding to the image generation manner based on the target image and a machine-generated image generated in the image generation manner.

15. The apparatus according to claim 14, wherein determining, by using a contrastive recognition model, the first probability value corresponding to the image generation manner based on the target image and a machine-generated image generated in the image generation manner comprises:
using the target image and one machine-generated image generated in the image generation manner as an input of the contrastive recognition model, and outputting the first probability value corresponding to the image generation manner by using the contrastive recognition model.

16. The apparatus according to claim 14, wherein determining, by using a contrastive recognition model, a first probability value corresponding to the image generation manner based on the target image and a machine-generated image generated in the image generation manner comprises:
generating a plurality of machine-generated images in the image generation manner;
establishing a plurality of image pairs, each of the image pairs comprising the target image and one of the plurality of machine-generated images generated in the image generation manner;
inputting the plurality of image pairs to the contrastive recognition model, outputting second probability values respectively corresponding to the plurality of image pairs by using the contrastive recognition model; and
determining the first probability value corresponding to the image generation manner based on the second probability values respectively corresponding to the plurality of image pairs.

17. The apparatus according to claim 12, wherein the processor is further configured to implement:
classifying the target image by using a classification model, to obtain a third probability value of the target image, the third probability value indicating a probability that the target image is the machine-generated image; and
determining, in response to that the third probability value and the N first probability values respectively corresponding to the N image generation manners satisfy a second condition, that the target image is the machine-generated image.

18. The apparatus according to claim 17, wherein the classifying the target image by using a classification model, to obtain a third probability value of the target image comprises:
classifying the target image by using the classification model, to obtain N fourth probability values, each of the N fourth probability values indicating a probability that the target image is generated in one of the N image generation manners respectively;
performing summation on the N fourth probability values, to obtain a summation result of the N fourth probability values; and
determining the third probability value based on the summation result of the N fourth probability values.

19. The apparatus according to claim 17, wherein the determining, in response to that the third probability value and the N first probability values respectively corresponding to the N image generation manners satisfy a second condition, that the target image is the machine-generated image comprises:
obtaining an extremum value in the N first probability values respectively corresponding to the N image generation manners, the extremum value being a maximum value or a minimum value of the N first probability values;
determining a combined probability value based on the extremum value and the third probability value; and
determining, in response to that the combined probability value is greater than or equal to a threshold, that the target image is the machine-generated image.

20. A non-transitory computer-readable storage medium, having a computer program stored therein, the computer program being loaded and executed by a processor to implement:
obtaining description information of a target image to be recognized;
performing image generation based on the description information of the target image in N image generation manners respectively, to obtain N machine-generated images, N being a positive integer greater than 1;
comparing the target image with the N machine-generated images respectively, to obtain N first probability values respectively corresponding to the N image generation manners, each of the N first probability values indicating a probability that the target image is generated in the corresponding image generation manner; and
determining, in response to that a first probability value corresponding to one of the N image generation manners is not less than a first threshold, that the target image is the machine-generated image.
